(19) United States
(12) Patent Application Publication
(10) Pub. No.: US 2013/0127727 A1
(43) Pub. Date: May 23, 2013

(54) E-BOOK READER FOR DISABLED INDIVIDUALS

(71) Applicant: Catherine ALLEN, Portland, OR (US)

(72) Inventor: Catherine ALLEN, Portland, OR (US)

(21) Appl. No.: 13/679,832

(22) Filed: Nov. 16, 2012

Related U.S. Application Data
(60) Provisional application No. 61/561,112, filed on Nov. 17, 2011.

(51) Int. Cl. G06F 3/02

(52) U.S. Cl. CPC G06F 3/02
USPC 345/168; 345/156

(57) ABSTRACT

An electronic device suitable to read textual materials thereon for disabled individuals includes a device having a size less than 12 inches by 12 inches, less than 1 inch thick, and includes a front surface with a display suitable for displaying at least one of text and images thereon. The device includes a turn button that when selected selects a page turning duration where a first page of an electronic book is presented on the display and based upon the page turning duration a subsequent page of the electronic book is presented on the display.

### CROSS-REFERENCE TO RELATED APPLICATIONS

Not applicable.

### BACKGROUND OF THE INVENTION

The present invention relates generally to an electronic e-book reader for disabled individuals.

An electronic book reader, generally referred to as an e-book reader, has been developed which include a wireless communication mechanism to receive electronic books which can be displayed on a display. The e-book reader has the ability to display text and image-based publications in digital form produced on, published by, and readable on the device. Sometimes the equivalent of a conventional printed book, e-books can be originally developed in electronic form. In addition, personal computers, tablets, and cell phones can also be used to read e-books. Unfortunately, those with Parkinson disease or other physical disabilities have difficulty in accurately controlling the page turning function. Depending on the layout of the device, turning the page requires exorbitant effort.

What is desired is an electronic book reader that provides a suitable interface for turning the page, especially for those with significant disabilities.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an e-book reader.

FIG. 2 illustrates a modified e-book reader.

### DETAILED DESCRIPTION OF PREFERRED EMBODIMENT

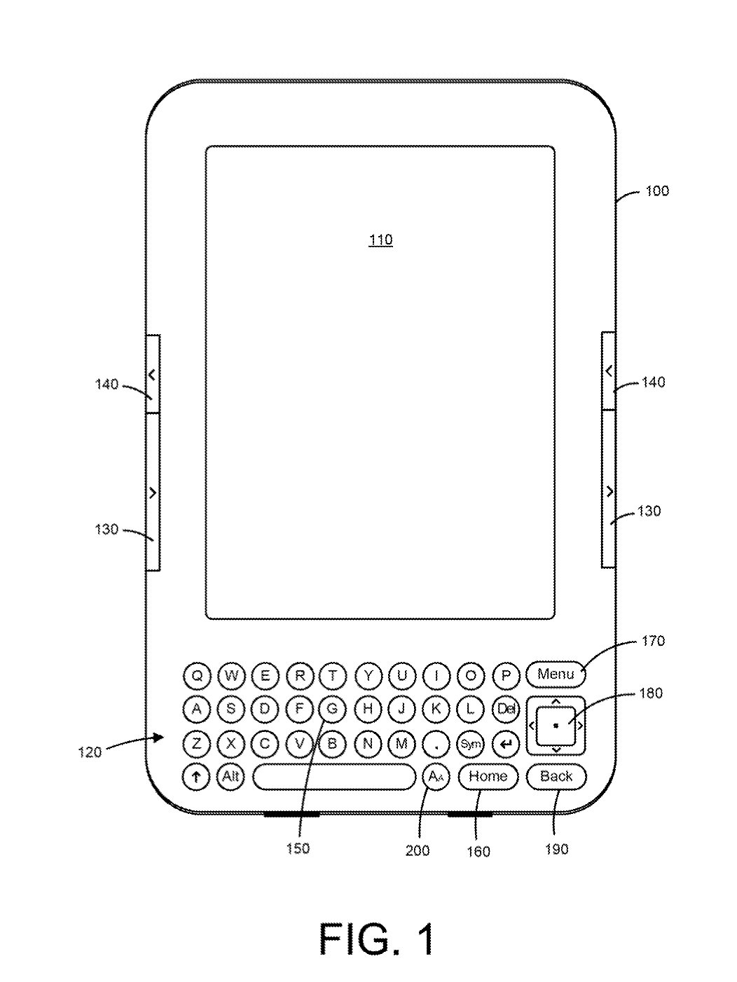

Referring to FIG. 1, an e-book reader 100 typically has a size less than 12 inches by 12 inches, and more preferably smaller than 8½ inches by 11 inches. The thickness of the e-book reader 100 is typically less than 1 inch thick, and more preferably less than ½ inch thick. In this manner, the e-book reader 100 is a handheld device suitable for reading a book thereon. The front of the e-book reader 100 includes a display 110. The display is typically constructed from a passive matrix or active matrix liquid crystal, although other display techniques may likewise be used. The display 110 preferably encompasses a majority of the front surface of the e-book reader 100. The majority of the frontal surface and the majority of the rear surface of the e-book reader 100 are preferably substantially flat. The e-book reader may be in the form of a cellular phone, a tablet, or other computing device. In some embodiments, the front of the e-book reader includes a physical keyboard 120. In other embodiments, the front of the e-book reader includes a virtual keyboard that is accessible through touching the display 110. In many cases, the display 110 includes a touch sensitive layer or a capacitive/resistive sensitive layer thereon facilitating interaction with the e-book reader 100.

The e-book reader 100 may include one or more keys to turn to a next page 130 of a book and one or more keys to turn to a previous page 140 of a book. In addition to the letter keys 150, the e-book reader 100 may include a home button 160 to return to a main menu displayed in the display 110, a menu button 170 to display a menu of options in the display 110, a selection button 180 to select an option from within the menu in the display 110, and a back button 190 to return back from a item selected with the selection button 180. In this manner, the user of the device may navigate the options of the device. A text scale button 200 provides a menu where the user may select the size of the text to be displayed on the display 110.

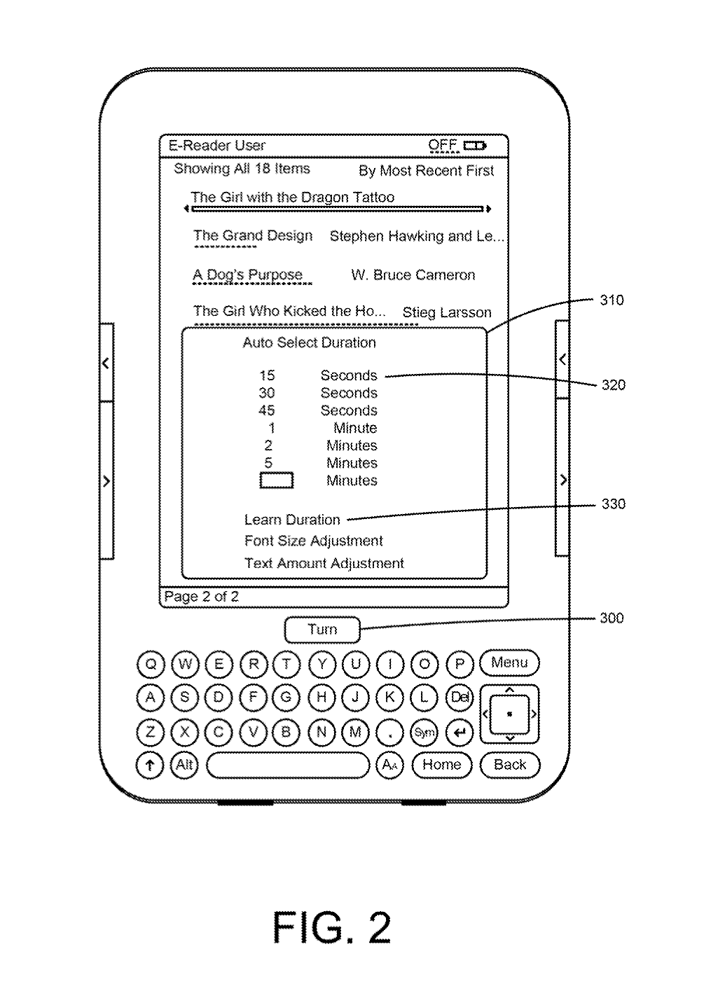

Referring to FIG. 2, a turn button 300 selects page turning features. The turn button 300 (and any other buttons or selectors desired) may be virtual, if desired, such as presented on the display. By depressing the turn button 300 a sufficient duration a set of page turning functions 310 are presented on the display 110. A first page turning function is an auto select duration 320. The auto select duration 320 sets a timing during which a page of an article or book is presented on the display 110. After the duration has expired, then the next page in the book is presented, and so forth. In this manner, someone with disabilities such as Parkinson's disease or other physical and mobility impairments, will not have to fumble with the traditional page turning keys to turn to the next page. There are several types of orthopedic and/or neuromuscular impairments that can impact mobility. Such impairments include, for example, amputation, paralysis, cerebral palsy, stroke, multiple sclerosis, muscular dystrophy, arthritis, and spinal cord injury. Mobility impairments encompass a wide range, such as from lower body impairments, which may require use of canes, walkers, or wheelchairs, to upper body impairments which may include limited or no use of the upper extremities and hands.

The auto select duration 320 includes a set of predefined durations or permits the user to enter the desired duration. Thus, after pre-selecting the auto select duration 320, the user would navigate to an e-book that he desires to read. The turn button 300 would be selected, and the e-book would automatically change to the next page in the book after the selected duration has expired.

Once programmed, page turning functions 310 may also be controlled by the user's voice. Once a particular page turning function is programmed 320, 330, a user may temporarily override the programmed duration by (1) accelerating the rate a page of text is advanced; (2) recall the previous page of text; and/or (3) pause and/or restart the page turning function by employing voice commands, such as “next,” “back,” “stop” and “start” by speaking into/near a small speaker at the top of the reader 100 (not shown). The functionality of the speaker may be turned on and off at the user's discretion using a button and/or a voice command.

The page turning functions 310 may also include a learn duration 330. The learn duration 330 would present the user with a selected page of textual material, after which the user indicates completion of reading of the text, such as by depressing any button. The reader 100 calculates the time during which it took the reader to read the selected page of text and uses this as the auto select duration 320 time or based upon the time it took to read the selected page. This permits the reader 100 to more accurately determine the time it takes a particular user to read a page.

The page turning functions 310 may further include the capability of being dependent on the amount of text on a page and/or the size of the fonts presenting the text on the page. In some cases, a user with poor vision will desire large fonts so there are few words on the page, and thus typically will not take long to read. Other users will desire small fonts so there are many words on the page, and thus typically will take considerably longer to read. The page turning functions 310 may include a text amount adjustment 340 to automatically account for the differences in the event the user later changes the textual settings. Moreover, the page turning functions 310 may be dependent on displaying images on the page, and when this occurs decreasing the time before the page turns accordingly, since the user does not need to read the image.

The page turning functionality may likewise be controlled by voice commands. In this manner, the user may use simple commands, such as one word commands, to control the device. For example, the user may use the word “read” to initialize the page turning functionality. For example, the user may use the word “turn” to turn the next page. For example, the user may use the word “back” to turn to the previous page. For example, the user may use the word “forward” to start the auto-turning functionality. For example, the user may use the word “stop” to stop the auto-turning functionality. For example, the user may use the word “pause” and “resume” to halt and continue the auto-turning functionality. For example, the user may use the word “chapter” to progress to the next chapter.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. An electronic device suitable to read textual materials thereon for disabled individuals comprising:
(a) said device having a size less than 12 inches by 12 inches;
(b) said device having a thickness less than 1 inch thick;
(c) said device including a front surface including a display suitable for displaying at least one of text and images thereon;
(d) said device including a turn button that when selected selects a page turning duration where a first page of an electronic book is presented on said display and based upon said page turning duration a subsequent page of said electronic book is presented on said display.

2. The device of claim 1 wherein said device has said size less than 8.5 inches by 11 inches.

3. The device of claim 2 wherein said device has said thickness less than 0.5 inches thick.

4. The device of claim 3 wherein said front surface is substantially flat.

5. The device of claim 4 wherein said device includes a substantially flat back surface opposing said front surface.

6. The device of claim 1 wherein said front surface includes a virtual keyboard thereon.

7. The device of claim 1 wherein said page turning duration is selected from a list of durations.

8. The device of claim 1 wherein said page turning duration is controllable via said device receiving a voice command.

9. The device of claim 8 wherein said duration is temporally overridden by receiving a voice command, and then automatically reverts back to said page turning duration.

10. The device of claim 1 wherein said page turning duration is learned by said device as a result of use of said device.

11. The device of claim 10 wherein said learning is based upon the time it took to read a page.

12. The device of claim 1 wherein said page turning duration is based upon the amount of text displayed on said display.

13. The device of claim 1 wherein said page turning duration is based upon the size of the font of text displayed on said display.

14. The device of claim 1 wherein said page turning duration is based upon images displayed on said display.
